(19) United States
(12) Patent Application Publication
(10) Pub. No.: US 2003/0026229 A1
(43) Pub. Date: Feb. 6, 2003

(54) Virtual data trunks between switching points using an IP network

(76) Inventors: Dave Larson, Solna (SE); Anders O. Werneman, Lund (SE); Doug Griswold, Cary, NC (US); Uday Reddy Dodla, Cary, NC (US); Freda Kuhfahl, Apex, NC (US)

Correspondence Address: COATS & BENNETT, PLLC, P O BOX 5, RALEIGH, NC, 27602, US

(21) Appl. No.: 09/915,967

(22) Filed: Jul. 26, 2001

(51) Int. Cl. H04Q 7/24

(52) U.S. Cl. 370/338; 370/349

(57) ABSTRACT

The dedicated telecommunications lines functioning as data trunks carrying voice and data between the switching points of a wireless communications system are replaced by virtual data trunks implemented over an Internet Protocol network. An IP gateway associated with each switching point receives a plurality of data trunks carrying communications data. The data are assembled into IP packets, with a source address associated with the gateway and a destination address derived from which data trunk carried the communications data. The IP packets are sent across an IP network to the destination gateways. Incoming data packets, with a destination IP address matching that associated with the IP gateway, are received at the gateway. The data are extracted from the IP packets, and directed to one of the data trunks to the switching point, based on the IP source address of the packet. The virtual data trunks provide a cost effective solution for connecting private wireless office systems to the public wireless communications system to enable handoff and roaming between the private and public systems.

### BACKGROUND OF THE INVENTION

The present invention relates generally to the field of wireless communications systems, and specifically to a system and method providing virtual data trunks between switching points in a wireless communications system.

Modern wireless communications systems have experienced a tremendous growth in popularity. Wireless communications service coverage is nearly universal, at least in most urban areas, and mobile communications handsets, or mobile terminals, are ubiquitous.

Modern wireless communications systems typically comprise a large plurality of radio access points, containing the antennas and radio frequency transceivers necessary to establish communications with mobile terminals, utilizing the electromagnetic spectrum, or the “radio air interface.” These antennas are typically mounted on towers to provide radio coverage over an extended geographical area. The antennas, radio transceivers, and communications equipment typically located at each tower are collectively referred to as a Base Transceiver Station (BTS). One or more BTSs are connected to a Mobile Switching Center (MSC), which controls the routing of communications—comprising voice and data—among BTSs and between BTSs and the Public Switched Telephone Network (PSTN).

Modern wireless communications systems include provisions for performing “handoffs.” A handoff occurs when a mobile terminal moves from one coverage area, or “cell,” to another, and an ongoing call is routed through the radio access point of the new cell.

To implement handoffs that occur across regional service area boundaries, the regionally located MSCs connect to each other via terrestrial telecommunications links. These links comprise two parts: a signaling connection and a data trunk. The signaling connection transfers configuration and control information, and supports the network functions necessary for implementation of roaming and handoff operations. The data trunk transfers the communication content—voice or data—from the MSC controlling the serving BTS to the mobile terminal user's home MSC. The data trunk typically comprises a dedicated T1 or E1 line, which is leased from a telecommunications service provider. To ensure universal handoff capability, each regional MSC must be connected via this signaling/data trunk pair to a large number of other MSC's, thus incurring a significant cost in leasing a large number of dedicated T1/E1 lines for the data trunks.

Another aspect of wireless communications systems that has experienced significant recent growth is the provision of wireless systems covering a limited geographical area, commonly referred to as Private Wireless Office Systems (PWOS). PWOSs are similar in structure to a public wireless communications system, comprising a plurality of radio interface units, each covering a limited geographic area, linked to and controlled by a central switching station, similar in function to the MSC. Localized wireless communications are attractive to many businesses, as users need not be tied to a physical location to be accessible via the company's communications network. A privately owned and operated wireless communication system is attractive as it eliminates air time charges, eliminates disruptions due to congestion over which the business has no control, and allows the business to control access to its communications facilities in a manner that is transparent to the user. To allow users to utilize their own mobile terminals within the PWOS, the PWOS complies with the same air interface standards utilized by the public wireless communication service providers. The standards include provisions for handoff of mobile terminals between switching points.

PWOSs are typically deployed within a building, or a small campus of buildings. Small, low-powered radio interface units called Radio Heads (RH) are placed strategically within the building, and potentially within common areas on a campus, to provide continuous wireless communications coverage within the geographic extent of the PWOS. As a user travels into or out of the building (or onto or off of the campus), a handoff from/to the public wireless communications system serving the surrounding region is necessary to prevent interruption of an ongoing call.

Implementing handoff to the regional public wireless communications system requires that the switching controller of the PWOS, known as a Control Radio Interface (CRI), be connected to the relevant public communications system MSC, with the signaling/data trunk link described above. Particularly the data trunk portion of this link, typically implemented via leased, dedicated T1/E1 lines, may not be cost effective for the PWOS, considering the relatively small volume of PWOS traffic that requires a handoff to the regional MSC. Additionally, to implement handoffs spanning more than one regional MSC, the PWOS CRI must maintain a signaling/data trunk link to multiple MSC's. The cost of maintaining multiple dedicated T1/E1 links, some of which may span significant geographic extents, is prohibitive for most PWOS operators. On the other hand, failure to maintain handoff ability to the local public wireless communications system compels an annoying, inconvenient, and disruptive break in wireless communications when users move into or out of the PWOS range.

### SUMMARY OF THE INVENTION

The present invention entails a method of routing call data between two switching points in a mobile communications system. The method comprises receiving the call data from a source switching point at a source IP gateway over one of several trunk circuits, packetizing the call data to format it into one or more IP data packets, assigning an IP destination address to the packets based on which trunk circuit the call data was received by the IP gateway, and transmitting the packets over an IP network to a destination switching point. The method further comprises receiving one or more IP data packets from an IP network at a destination IP gateway, assembling the call data from the received IP data packets, directing the call data to one of several trunk circuits based on the source IP address of the IP data packets, and transferring the call data to the destination switching point.

In one embodiment, the present invention entails an IP gateway to provide virtual trunks for routing call data between switching points in a mobile communications system. The gateway comprises a series of trunk circuits connected to a switching point and carrying said call data, an IP interface connected to an IP network, a data packetizer to packetize call data into one or more IP data packets, and an IP address generator to generate an IP destination address for the data packets based on which trunk circuit the call data was received from the switching point. The gateway further comprises a data assembler to assemble data packets received from an IP network into mobile communications system call data, and a switch directing the call data to one of a series of trunk circuits connected to a destination switching point, based on the IP source address associated with the received data packets.

### BRIEF DESCRIPTION OF DRAWINGS

FIG. 1 is a schematic view of a representative mobile communication system.

FIG. 2 is a schematic view of a portion of a representative mobile communication system, depicting an IP network providing virtual data trunks, according to the present invention.

FIG. 3 is a block diagram view of an IP gateway according to the present invention.

### DETAILED DESCRIPTION OF THE INVENTION

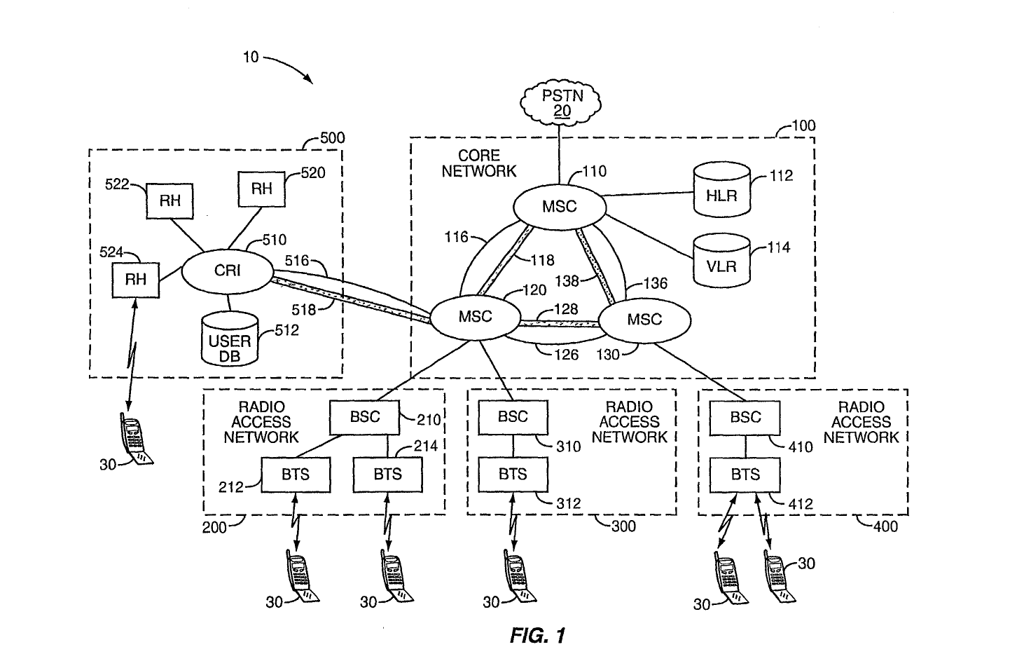

A representative mobile communications system is depicted in schematic form in FIG. 1. The mobile communications system, indicated generally by the numeral 10, comprises a Core Network 100 and a plurality of Radio Access Networks 200, 300, 400. The public mobile communications system 10 is connected to the Public Switched Telephone Network (PSTN) 20, and additionally to a Private Wireless Office System (PWOS) 500. Both the public wireless communications system 10 and the PWOS 500 are capable of communicating with mobile terminals 30 via the transmission and reception of electromagnetic signals across the radio air interface. The public wireless communications system 10 and PWOS 500, as depicted in FIG. 1, are representative only. They are depicted for the purposes of explication herein of the present invention, and should not be viewed as limiting the present invention in any manner.

The core network 100 performs the Call Control and Mobility Management functions of the public wireless communications system 10. In the example depicted in FIG. 1, the core network 100 comprises Mobile Switching Centers (MSC) 110, 120, and 130, a Home Location Register (HLR) 112 and a Visitor Location Register (VLR) 114. Each MSC 110, 120, 130 is typically located in a different geographical region, and controls a plurality of radio access networks 200, 300, 400 located throughout its region. Signaling link 116 and data trunk 118 connect MSC 110 and MSC 120; signaling link 126 and data trunk 128 connect MSC 120 and MSC 130; and signaling link 136 and data trunk 138 connect MSC 130 and MSC 110. Although the PSTN 20 is shown attached only to MSC 100, in general, each MSC 110, 120, 130 may maintain a connection to the PSTN 20.

Associated with at least one MSC 110, 120, 130 is a Home Location Register 112. The HLR 112 contains subscriber data associated with each authorized user of the public wireless communications system 10 whose “home” location is within the region served by the respective MSC 110, 120, 130. The HLR 112 contains information such as subscribers' names and billing addresses, mobile terminal identification numbers, subscribers' authorized/prepaid services, and the like. Also associated with at least one MSC 110, 120, 130 is a Visitor Location Register 114. The VLR 114 contains information associated with subscribers to the public wireless communications system 10 whose mobile terminal 30 is active and detected by a radio access network 200, 300, 400 within the region served by the associated MSC 110, 120, 130, but whose “home” MSC is elsewhere. The VLR 114 thus functions as a “dynamic HLR,” maintaining information on visiting mobile terminal 30 users. The VLR 114, HLR 112, and MSCs 110, 120, 130 cooperate, exchanging signaling and network management information across signaling links 116, 126, 136, to implement a broad range of system features and functions, including handoff across radio access points associated with different MSCs 110, 120, 130. In these situations, the content of the call, i.e., voice or data communications, is transferred between the “home” MSC 110, 120, 130 and the active MSC 110, 120, 130 (i.e., the MSC 110, 120, 130 associated with the serving radio access network through which the mobile terminal 30 has established communications) via data trunks 118, 128, 138.

The Radio Access Networks 200, 300, 400 perform the Radio Resource Management functions of the wireless communications system 10. Each Radio Access Network 200, 300, 400 is associated with one MSC 110, 120, 130 of the Core Network 100. Radio Access Network 200 comprises Base Station Controller (BSC) 210, which controls Base Transceiver Stations (BTS) 212 and 214. The BTSs 212, 214 contain the antennas, radio frequency receivers, and switching equipment necessary to establish radio communications with mobile terminals 30 within their geographic range, or cell. BSC 210 transfers call data between BTSs 212, 214 and MSC 120. Additionally, BSC 210 may transfer call data among and between BTSs 212 and 214 under certain circumstances, such as for example a call whose origin and destination are both within the cells served by BTSs 212, 214, or when a call is handed off between BTS 212 and 214. Similarly, Radio Access Network 300 comprises BSC 310 and at least one BTS 312. Radio Access Network 300 is additionally under the control of MSC 120. Radio Access Network 400, controlled by MSC 130, comprises BSC 410 and BTS 412.

The public mobile communications system 10 implements handoff of a mobile terminal 30 from one cell to another in a variety of ways, depending on the configuration of the network serving the two cells. In intra-MSC handoffs, the handoff is completed entirely under the control of a single MSC 110, 120, 130. In inter-MSC handoffs, call data must be routed from one MSC 110, 120, 130 to another MSC 110, 120, 130. The network resources and control configurations implicated by a handoff are determined by the location of the switching point (SP). Referring to FIG. 1, in a handoff of a mobile terminal 30 from BTS 212 to BTS 214, the BSC 210 is the SP. Since the call data in this case is routed only through MSC 120, this is an intra-MSC handoff. Similarly, a handoff of a mobile terminal 30 from BTS 214 to BTS 312 is an intra-MSC handoff. In this case, the SP is the MSC 120. In contrast, a handoff from BTS 312 to BTS 412 is an inter-MSC handoff. In this case, both MSC 120 and MSC 130 are SPs. In this handoff scenario, the call established at MSC 120 (for example, to a point in the PSTN 20) is maintained by the MSC 120. As the mobile terminal 30 establishes communications with the BTS 412, the communications (comprising either voice or data) are transferred from MSC 120 across data trunk 128 to MSC 130, and thence through Radio Access Network 400 to the mobile terminal 30.

Inter-MSC handoffs may involve more than two MSCs 110, 120, 130. For example, consider a call established between a point in the PSTN 20 and a mobile terminal 30 in communication with BTS 312. The communications data in this case is routed by MSC 120 through BSC 310 to BTS 312. As the mobile terminal 30 moves into the cell served by BTS 412, a first inter-MSC handoff will occur. The original, or “anchor” MSC 120 will perform network configuration and call set-up over signaling link 126 to MSC 130. MSC 130 will allocate a channel through BSC 410 to prepare BTS 412 to receive the handoff (MSC 130 will additionally create an entry in VLR 134). Upon handoff of mobile terminal 30 from BTS 312 to BTS 412, MSC 120 will route the call communications across data trunk 128 to MSC 130. Suppose the mobile terminal 30 were to subsequently enter a cell served by a Radio Access Network associated with MSC 110 (not shown). Rather than maintain a multi-hop data link from the anchor MSC 120 across data trunk 128 to MSC 130, and thence across data trunk 138 to MSC 110, the Core Network 100 will perform path minimization. In this process, utilizing information in HLR 112 and VLR 114, via signaling links 126, 136, and 116, a direct connection will be established between the anchor MSC 120 and the new active MSC 110, via signaling link 116, and transferring call communications across data trunk 118 to MSC 110.

Hence, to most efficiently implement inter-MSC handoff, total interconnection is required, i.e., each MSC 110, 120, 130 is ideally connected to every other MSC 110, 120, 130 in the network via a signaling/data trunk connection pair. This is feasible for a relatively small number of MSCs 110, 120, 130, each covering a large regional area. However, as the number of MSCs 110, 120, 130 increases, total interconnectivity becomes cost prohibitive, particularly with respect to the data trunks 118, 128, 138, which are typically leased, dedicated E1/T1 telecommunications links, some of which must span considerable geographical distance. The number of effective MSCs 110, 120, 130 is expected to increase dramatically, as an increasing number of Private Wireless Office Systems 500 join the network 10.

A representative Private Wireless Office System (PWOS) 500 is also shown in FIG. 1. PWOS 500 comprises a Control Radio Interface (CRI) 510, a plurality of Radio Heads (RH) 520, 522, and 524, and a user database 512. CRI 510 performs call routing and controls the radio access points of PWOS 500. In this respect, it is functionally similar to a MSC 110, 120, 130 of the public wireless communications system 10. Radio Heads 520, 522, 524 comprise the antennas and radio frequency transceivers necessary to establish radio communications with mobile terminals 30 within their operating range. The RHs 520, 522, 524 operate under the control of the CRI 510, and are functionally analogous to the Base Transceiver Stations 212, 214, 312, 412 of the public wireless communications system 10. The user database 512 contains information associated with all authorized users of the PWOS 500. The user database 512 is functionally analogous to a combination of the HLR 112 and VLR 114 of the public wireless communications system 10.

To implement handoff of mobile terminals 30 entering and leaving the area covered by PWOS 500, the CRI 510 is connected to the regional MSC 120 of the public wireless communications system 10, via signaling link 516 and data trunk 518. Handoffs between the PWOS 500 and the public wireless communications system 10 are relatively rare, comprising approximately 3% of the PWOS 500 traffic in some cases. Given this relatively small percentage traffic load, maintaining a dedicated T1/E1 data trunk 518 to MSC 120 may not be cost effective for the PWOS 500. As described above, for the PWOS 500 to implement inter-MSC handoff beyond MSC 120, CRI 510 would need a signaling/data trunk connection to every other MSC 110, 130 of the public wireless communications system 10 to or from which it anticipated transferring calls. For the vast majority of PWOSs 500, maintaining a plurality of data trunks connecting CRI 510 with multiple MSCs 110, 130 would be cost prohibitive. However, this functionality is desirable, and as wireless communications systems continue to increase in sophistication, the demand for such functionality is likely to increase.

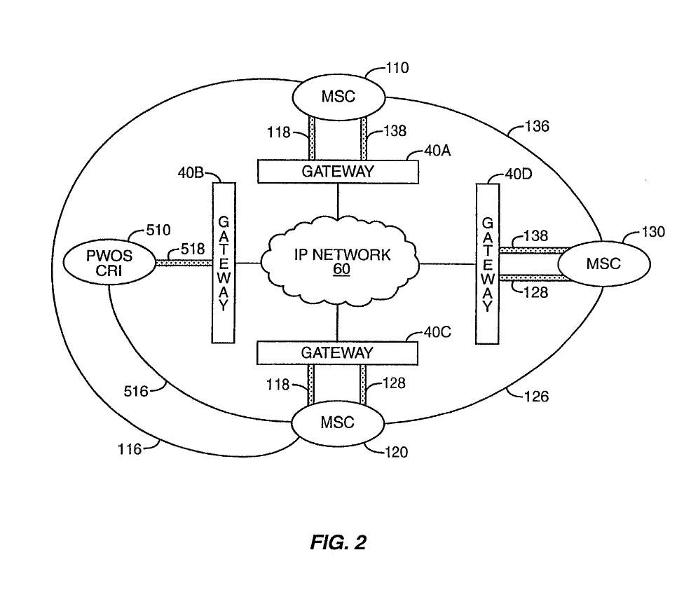

According to the present invention, the need for leased, dedicated T1/E1 links over large geographic distances to serve as inter-MSC data trunks is obviated by replacing these trunks with an Internet Protocol (IP) network and a plurality of associated IP gateways. Referring to FIG. 2, the network of the present invention is shown. Each MSC 110, 120, 130 retains its data trunk connections, 118/138, 118/128, and 128/138, respectively. However, these data trunks extend only to an IP gateway 40A, 40C, 40D located physically proximate each MSC 110, 120, 130, respectively. Each gateway 40 then connects to an IP network 60. The signaling links 116, 126, and 136 are retained between each MSC. Similarly, the PWOS CRI 510 connects via data trunk 518 to an IP gateway 40B, which connects to the IP network 60. The PWOS CRI 510 additionally connects via signaling link 516 to MSC 120, and may additionally be connected to other MSCs 110, 130, as desired. In the network configuration of FIG. 2, a “virtual data trunk” is dynamically established between each CRI 510 and/or MSC 110, 120, 130, through the IP network 60 as needed. IP data packets representing call communications—voice or data—are routed through the IP network 60 based upon which data trunk 118, 128, 138, 518 carried the communications from the associated MSC 110, 120, 130 or CRI 510.

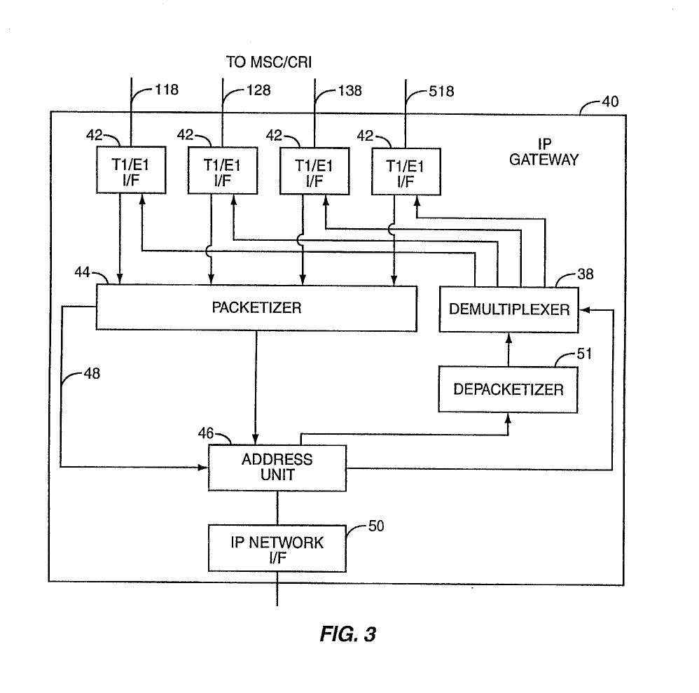

The IP gateway according to the present invention is depicted in block diagram form in FIG. 3. The IP gateway 40 contains a plurality of T1/E1 interface modules 42, a packetizer 44, an address unit 46, an IP network interface 50, and a demultiplexer 52. One or more data trunks, for example, data trunks 118, 128, 138, and/or 518 in the preceding examples, connect the IP gateway 40 to an MSC 110, 120, 130 or CRI 510. The data trunks, each comprising a T1/E1 line, connect to a corresponding plurality of T1/E1 interfaces 42. The interface 42 provides an electrical and logical interface complying with the T1/E1 telecommunications protocol. This interface allows the IP gateway 40 to be directly connected to an MSC 110, 120, 130 or CRI 510 without modification of its interfaces, and without requiring an intervening protocol converter. The T1/E1 interface 42 additionally allows the IP gateway 40 to be retrofitted to existing MSCs 110, 120, 130 and CRIs 510. Outgoing data from the T1/E1 interface 42 proceeds to the packetizer 44, where it is assembled into Internet Protocol (IP) compliant packets. The IP packets proceed to the address unit 46. At the address unit 46, a source address unique to each IP gateway 40 is appended to each outgoing IP packet. Address unit 46 also formulates a destination address and associates it with each IP packet. The destination address is selected based on which data trunk 118, 128, 138 or 518 carried the incoming communications data. This information is transferred to the address unit 46 from the packetizer 44 via circuit 48. The assembled and addressed IP data packets are then transferred to the IP network interface 50, where they are formatted to the appropriate physical layers of the IP network 60 (e.g., DSL, ATM, SONET, or the like).

An example of the source and destination IP addresses associated with data packets transferred from each MSC 110, 120, 130 and CRI 510, and their relationship to the data trunks carrying the call communications, is depicted in Table 1. The IP addresses depicted in Table 1 are Class C addresses, but this is for purposes of explication only. In practice, the addresses may conform to any addressing scheme implemented by the IP network 60. In Table 1, the fourth digit of the IP address represents the MSC 110, 120 130 or CRI 510 that is the source or destination of the associated data packet.

TABLE 1
Example of Outgoing Source and Destination IP Addresses

| | | IP Addresses of Data Packets | |
|---|---|---|---|
| | Call Data Transferred | Source | Destination |
| Gateway | on Data Trunk | Address | Address |
| 40A | 118 | 200.16.1.1 | 200.16.1.2 |
| 40A | 138 | 200.16.1.1 | 200.16.1.3 |
| 40B | 510 | 200.16.1.5 | 200.16.1.2 |
| 40C | 118 | 200.16.1.2 | 200.16.1.1 |
| 40C | 128 | 200.16.1.2 | 200.16.1.3 |
| 40D | 138 | 200.16.1.3 | 200.16.1.1 |
| 40D | 128 | 200.16.1.3 | 200.16.1.2 |

Thus, for example, at IP Gateway 40a, call communications from MSC 110 carried on data trunk 118 would be assigned a destination address 200.16.1.2, representing MSC 120. Call communications from MSC 110 carried on data trunk 138 would be assigned a destination address 200.16.1.3, representing MSC 130. All call data packets originating from MSC 110 will be assigned a source address of 200.16.1.1.

Incoming IP packets, i.e., those whose destination IP address match the IP address of the IP gateway 40, are received at the IP network interface 50. The IP network interface 50 receives IP data packets from the IP network 60 and converts them into an intermediate electrical and logical format used by the IP gateway 40. The data packets are passed to the address unit 46, where the source and destination addresses are removed from the data packets. The data packets then proceed to the depacketizer 51, where the data is extracted from the various IP protocol headers and assembled from multiple packets into communications call data. The call data is forwarded to the demultiplexer 52, which directs the data to one of the plurality of T1/E1 interfaces 42, based on the IP source address associated with the data packets. Source address information is transferred to the demultiplexer 52 from the address unit 46 via circuit 54. The T1/E1 interface 42 receives the incoming communications data and formats the data into T1/E1 compliant data frames for transmission across data trunk 118, 128, 138 or 518 to the MSC 110, 120, 130 or CRI 510, respectively.

An example of the source and destination IP addresses associated with data packets transferred across the IP network 60 to each MSC 110, 120, 130 and CRI 510, and the data trunks to which the call data is routed, is depicted in Table 2.

TABLE 2
Example of Incoming Source and Destination IP Addresses

| | IP Addresses of Data Packets | | |
|---|---|---|---|
| | Source | Destination | Call Data Transferred |
| Gateway | Address | Address | on Data Trunk |
| 40A | 200.16.1.2 | 200.16.1.1 | 118 |
| 40A | 200.16.1.3 | 200.16.1.1 | 138 |
| 40B | 200.16.1.2 | 200.16.1.5 | 510 |
| 40C | 200.16.1.1 | 200.16.1.2 | 118 |
| 40C | 200.16.1.3 | 200.16.1.2 | 128 |
| 40D | 200.16.1.1 | 200.16.1.3 | 138 |
| 40D | 200.16.1.2 | 200.16.1.3 | 128 |

Thus, for example, at IP Gateway 40a, data packets received from IP network 60 with a source address of 200.16.1.2 (representing MSC 120) would be routed to data trunk 118 and transferred to MSC 110. Data packets received with a source address of 200.16.1.3 (representing MSC 130) would be routed to data trunk 138 and transferred to MSC 110. All data packets received by IP Gateway 40a have a destination address of 200.16.1.1.

In this manner, a single IP network 60 and a plurality of IP gateways 40 may replace the dedicated data trunks interconnecting MSCs 110, 120, 130 and CRIs 510 in public and private wireless communications systems. The IP network 60 may be a private, dedicated, managed IP network utilizing a high-speed, high-reliability telecommunications protocol (e.g., DSL, ATM, SONET, or the like), thus ensuring minimum data transfer latency and maximum reliability.

The IP network 60 represents a considerable cost savings over leasing a plurality of dedicated E1/T1 trunks. To each MSC 110, 120, 130 or CRI 510, however, the substitution of an IP network 60 for the dedicated data trunks 118, 128, 138, 518 is transparent. Data sent to a specific MSC or CRI, i.e., on a specific data trunk line, receives a corresponding IP destination address and is routed through the IP network 60 to the appropriate MSC or CRI. Incoming data (i.e., data packets with an IP destination address corresponding to an IP gateway 40) are directed to one of data trunks 118, 128, 138, or 518, in response to the IP packet's source address. Thus, the routing of data through the IP network 60 via IP gateways 40, in lieu of across multiple dedicated T1/E1 lines, is completely transparent to the attached MSCs 110, 120, 130 and CRI 510. This allows the virtual data trunks of the present invention to be designed into wireless communication networks directly, without any redesign, upgrade, retrofit, or intermediate protocol conversion to the I/O of MSCs 110, 120, 130 or CRI 510. Additionally, dedicated T1/E1 data trunks currently connecting existing MSCs 110, 120, 130 and CRI 510 may be replaced with virtual data trunks according to the present invention, resulting in significant cost savings with little or no concomitant decrease in performance. Furthermore, the two approaches may be mixed in heterogeneous networks—for example, with MSCs 110, 120, 130 interconnected via dedicated T1/E1 links, and PWOS CRIs 510 connected to the MSCs 110, 120, 130 via virtual data trunks.

The IP gateway 40 and IP network 60 may be assembled using a wide variety of commercially available IP interface technology, further decreasing the cost of providing virtual data trunks between MSCs and CRIs. Particularly for PWOSs 500 that wish to maintain connections to a plurality of MSCs in a public wireless communications system 10 for the implementation of occasional handoff services, the virtual data trunks of the present invention represent a cost-effective solution.

Although the present invention has been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the spirit and scope of the invention. The present embodiments are therefore to be construed in all aspects as illustrative and not restrictive and all changes coming within the meaning and equivalency range of the appended claims are intended to be embraced therein.

What is claimed is:

1. A method of routing call data between two switching points, comprising:
receiving said call data from a source switching point at an IP gateway having at least one trunk circuit connecting said gateway to said source switching point, said call data transferred on one of said trunk circuits;
packetizing said call data at said IP gateway to format said call data into one or more data packets suitable for transmission over an IP network;
assigning an IP destination address to said packet data based on which said trunk circuit said call data was received by said IP gateway; and
transmitting said packets over an IP network to a destination switching point.

2. The method of claim 1, further comprising:
receiving one or more data packets from an IP network at an IP gateway connected to a destination switching point by at least one trunk circuit;
assembling said call data from said received data packets;
directing said call data to one of said trunk circuits based on a source IP address associated with said data packets; and
transferring said call data to said destination switching point.

3. The method of claim 1, wherein said at least one trunk circuit connecting said gateway to said source switching point comprises a plurality of trunk circuits connecting said gateway to said source switching point.

4. A method of routing call data between two switching points, comprising:
receiving one or more data packets from an IP network at an IP gateway connected to a destination switching point by at least one trunk circuit;
assembling said call data from said received data packets;
directing said call data to one of said trunk circuits based on a source IP address associated with said data packets; and
transferring said call data to said destination switching point.

5. A method of routing mobile communication system call data through an IP network, comprising:
transmitting call data from a switching point to an IP gateway on one of at least one trunk circuit connecting said switching point to said IP gateway;
packetizing said call data at said IP gateway to format said call data into one or more data packets suitable for transmission over an IP network;
assigning an IP destination address to said data packets at said IP gateway based on which of said trunk circuits said call data was transferred from said switching point to said IP gateway;
assigning an IP source address to all said data packets, wherein said IP source address is associated with said IP gateway; and
transmitting said data packets over an IP network.

6. The method of claim 4, further comprising:
receiving one or more data packets from said IP network at an IP gateway connected to a destination switching point by at least one trunk circuit;
assembling said call data from said data packets;
directing said call data to one of said trunk circuits based on an IP source address associated with said data packets; and
transmitting said call data from said IP gateway to said destination switching point.

7. The method of claim 4, wherein said at least one trunk circuit connecting said switching point to said IP gateway comprises a plurality of trunk circuits connecting said switching point to said IP gateway.

8. A method of routing mobile communications system call data through an IP network, comprising:
receiving one or more data packets from said IP network at an IP gateway connected to a destination switching point by at least one trunk circuit;
assembling said call data from said data packets;
directing said call data to one of said trunk circuits based on an IP source address associated with said data packets; and
transmitting said call data from said IP gateway to said destination switching point.

9. An IP gateway to provide virtual trunks for routing call data between switching points in a mobile communications system, comprising:
at least one trunk circuit connected to a switching point in said mobile communications system, said at least one trunk circuit carrying said call data;
an IP interface connected to an IP network;
a data packatizer to packatize call data received by said IP gateway on said trunk circuits into one or more data packets suitable for transmission over said IP network; and
an IP address generator to generate an IP destination address for said data packets based on which of said at least one trunk circuit said call data was received from said switching point by said IP gateway.

10. The IP gateway of claim 7, further comprising:
a data depacketizer to assemble data packets received from said IP network into mobile communications system call data; and
a demultiplexer directing said call data to one of said at least one trunk circuits based on an IP source address associated with said data packets.

11. The IP gateway of claim 7, wherein said at least one trunk circuit connected to a switching point comprises a plurality of trunk circuits connected to said switching point.

12. An IP gateway to provide virtual trunks for routing call data between switching points in a mobile communications system, comprising:
at least one trunk circuit connected to a switching point in said mobile communications system, said at least one trunk circuit carrying said call data;
an IP interface connected to an IP network;
a data depacketizer to assemble data packets received from said IP network into mobile communications system call data; and
a demultiplexer directing said call data to one of said at least one trunk circuits based on an IP source address associated with said data packets.
